(19) United States
(12) Patent Application Publication
(10) Pub. No.: US 2014/0153290 A1
(43) Pub. Date: Jun. 5, 2014

(54) DC/DC CONVERTER WITH VARIABLE OUTPUT VOLTAGE

(71) Applicant: EATON CORPORATION, Cleveland, OH (US)

(72) Inventors: YUEHUI LI, Shenzhen (CN); Jack GU, Shenzhen (CN); Yuefeng YANG, Shenzhen (CN)

(73) Assignee: EATON CORPORATION, Cleveland, OH (US)

(21) Appl. No.: 13/692,238

(22) Filed: Dec. 3, 2012

(51) Int. Cl. H02M 3/335

(52) U.S. Cl. CPC H02M 3/33569; H02M 3/33507
USPC 363/17

(57) ABSTRACT

A DC/DC converter includes a transformer having a primary winding electrically connected to a resonant network and a secondary winding having a plurality of taps including a common tap, a first tap, and a second tap. The DC/DC converter further includes a plurality of rectifier circuits including a first rectifier circuit electrically connected to the common tap, a second rectifier circuit electrically connected to the first tap, and a third rectifier circuit electrically connectable to the second tap. The DC/DC converter also includes a switch electrically connected between the second tap and the third rectifier circuit. The switch is operable to electrically connect and disconnect the third rectifier circuit from the second tap.

### BACKGROUND

1. Field

The disclosed concept pertains generally to direct current to direct current (DC/DC) converters and, more particularly, to DC/DC converters with variable output ranges.

2. Background Information

A DC/DC converter is configured to receive an input direct current (DC) voltage and convert it into one or more output DC voltages. In many applications, such as electric vehicle chargers, a DC/DC converter must be able to provide a relatively wide output voltage range. For example, the electric vehicle charging voltage range required by the US SAE is 200-450 VDC.

One type of DC/DC converter is an LLC resonant converter. LLC resonant converters provide high efficiency, low levels of EMI emissions, high power density, and low cost. However, in prior LLC resonant converter designs, increasing the output voltage range detrimentally affects the efficiency of the LLC resonant converter by causing a larger shunt current in the primary side, thus increasing conduction loss.

Some prior LLC resonant converter designs have obtained a wider output range. In one prior configuration, a buck stage is added after the LLC stage, thus allowing a wider output voltage range. However, adding a buck stage increases the cost of the LLC resonant converter.

Another prior LLC resonant converter configuration is shown in FIG. 1. A primary side of the LLC resonant converter receives an input voltage V_{IN}. The primary side of the LLC resonant converter includes a full-bridge circuit 10 which receives the input voltage V_{IN} and drives a resonant network 20. The resonant network 20 is electrically connected to the primary winding of a transformer 30.

The secondary winding of the transformer 30 includes a common tap 31, two primary taps 32,32′ electrically connected to a primary rectifier circuit 40, and two secondary taps 33,33′ electrically connected to a secondary rectifier circuit 41. The LLC resonant converter also includes a switch 50 which is electrically connected to the secondary rectifier circuit 41. Closing the switch 50 allows current to flow through the secondary rectifier circuit 41, thus increasing the output voltage V_{OUT} of the LLC resonant converter. The LLC resonant converter also includes a filtering capacitor 60 electrically connected across its output terminals.

While the secondary rectifier circuit 41 and switch 50 provide an extended output voltage range to the LLC resonant converter configuration of FIG. 1, this LLC resonant converter configuration is not well suited for use in relatively higher voltage applications. The diodes in the secondary rectifier circuit 41 are subjected to a voltage stress of about twice the level of the maximum output voltage V_{OUT}. As such, diodes with a relatively high forward voltage and low recovery speed will be used to cope with the voltage stress, thus detrimentally affecting the efficiency of the LLC resonant converter and increasing its cost.

Another prior LLC resonant converter configuration is shown in FIG. 2. A primary side of the LLC resonant converter receives an input voltage V_{IN}. The primary side of the LLC resonant converter includes a half-bridge circuit 110 which receives the input voltage V_{IN} and drives a resonant network 120. The resonant network 120 is electrically connected to the primary winding of a transformer 130.

The secondary winding of the transformer 130 includes a primary tap 131 and a secondary tap 132. A switch 150 is configured to electrically connect a rectifier circuit 140 to either the primary tap 131 or the secondary tap 132 of the secondary winding of the transformer 130, thereby changing the turns ratio of the transformer 130 and the output voltage V_{OUT}. The LLC resonant converter also includes a filtering capacitor 160 electrically connected across its output terminals.

While the secondary tap 132 and switch 150 extend the output voltage range of the LLC resonant converter configuration of FIG. 2, this LLC resonant converter configuration does not provide a path for current in the secondary side during the transition of the switch 150. This will result in a voltage spike on the windings of the transformer 130 and across the switch 150, and may damage the LLC resonant converter. Additionally, the output voltage V_{OUT} and current will drop substantially during the transition of the switch 150. To ensure reliable operation, the LLC resonant converter configuration of FIG. 2 should be shut down before switching the switch 150. However, in many applications, such as electric vehicle charging, shutting down the LLC resonant converter is not acceptable.

There is room for improvement in DC/DC converters.

### SUMMARY

These needs and others are met by embodiments of the disclosed concept in which a DC/DC converter includes a switch which is generally operable to electrically connect and disconnect a tap of a transformer and a rectifier circuit.

In accordance with aspects of the disclosed concept, a DC/DC converter configured to receive an input voltage and to output an output voltage comprises: a bridge circuit configured to receive the input voltage and including at least one pair of power switches; a resonant network driven by the bridge circuit; a transformer having a primary winding electrically connected to the resonant network and a secondary winding having a plurality of taps including a common tap, a first tap, and a second tap; a plurality of rectifier circuits configured to output the output voltage, the rectifier circuits including a first rectifier circuit electrically connected to the common tap, a second rectifier circuit electrically connected to the first tap, and a third rectifier circuit electrically connectable to the second tap; a switch electrically connected between the second tap and the third rectifier circuit, wherein the switch is operable to electrically connect and disconnect the third rectifier circuit from the second tap; and a control unit configured to control switching of the at least one pair of power switches.

Also in accordance with aspects of the disclosed concept, a DC/DC converter configured to receive an input voltage and to output an output voltage comprises: a bridge circuit configured to receive the input voltage and including at least one pair of power switches; a resonant network driven by the bridge circuit; a transformer having a primary winding electrically connected to the resonant network and a secondary winding having a plurality of taps including a common tap, a first tap, and a number of additional taps; a plurality of rectifier circuits configured to output the output voltage, the rectifier circuits including a first rectifier circuit electrically connected to the common tap, a second rectifier circuit electrically connected to the first tap, and a number of additional rectifier circuits electrically connectable to the number of additional taps, respectively; a number of switches electrically connected between the number of additional taps and the number of additional rectifier circuits, respectively, wherein the number of switches are operable to selectively electrically connect and disconnect the number of additional rectifier circuits from the number of additional taps; and a control unit configured to control switching of the at least one pair of power switches.

### BRIEF DESCRIPTION OF THE DRAWINGS

A full understanding of the disclosed concept can be gained from the following description of the preferred embodiments when read in conjunction with the accompanying drawings in which:

FIG. 1 is a circuit diagram of an LLC resonant converter configuration.

FIG. 2 is a circuit diagram of another LLC resonant converter configuration.

FIG. 3A is a circuit diagram of a DC/DC converter in accordance with an example embodiment of the disclosed concept.

FIG. 3B is a circuit diagram of a DC/DC converter in accordance with another example embodiment of the disclosed concept.

FIGS. 4A, 4B, 4C, and 4D are circuit diagrams showing the current path in the secondary side of the DC/DC converters of FIG. 3A or 3B.

FIG. 5 is a circuit diagram of the secondary side of a DC/DC converter in accordance with another example embodiment of the disclosed concept.

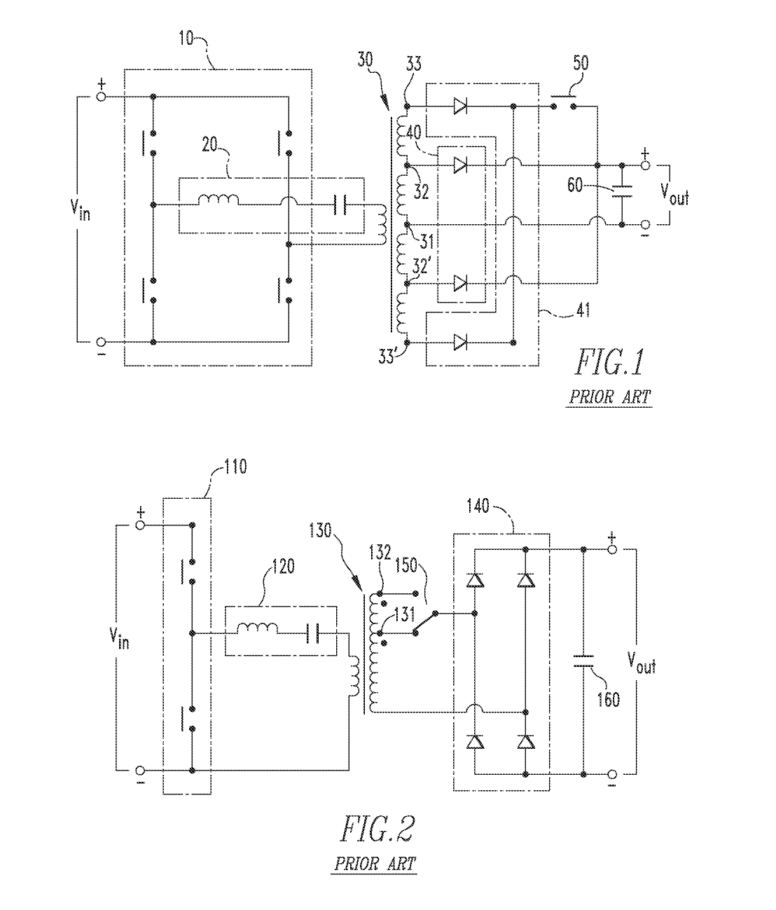

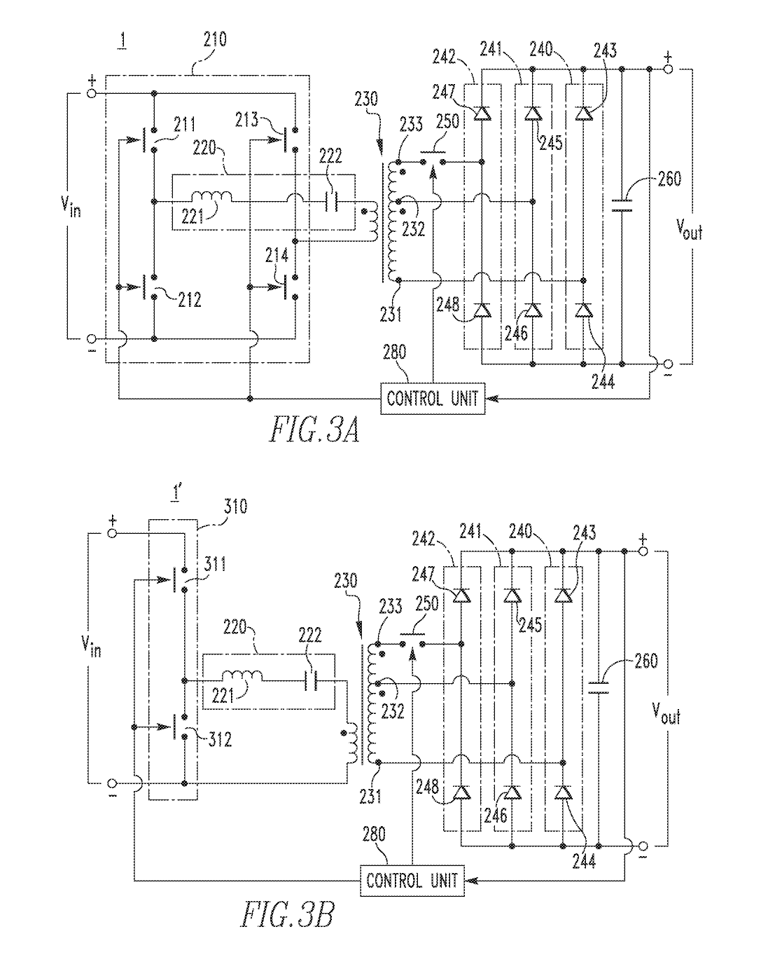

### DESCRIPTION OF THE PREFERRED EMBODIMENTS

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

As employed herein, the term “number” shall mean one or an integer greater than one (i.e., a plurality).

As employed herein, the statement that a component is on the “primary side of the DC/DC converter” and similar statements shall mean that the component is electrically connected, either directly or indirectly, to the primary winding of a transformer included in the DC/DC converter.

As employed herein, the statement that a component is on the “secondary side of the DC/DC converter” and similar statements shall mean that the component is electrically connected, either directly or indirectly, to the secondary winding of a transformer included in the DC/DC converter.

As employed herein, the term “switch” means any switch suitable for use in an electrical circuit. The term includes both mechanical type switches (e.g., without limitation, switches which physically separate contacts of the switch) and solid-state type switches (e.g., without limitation, transistors).

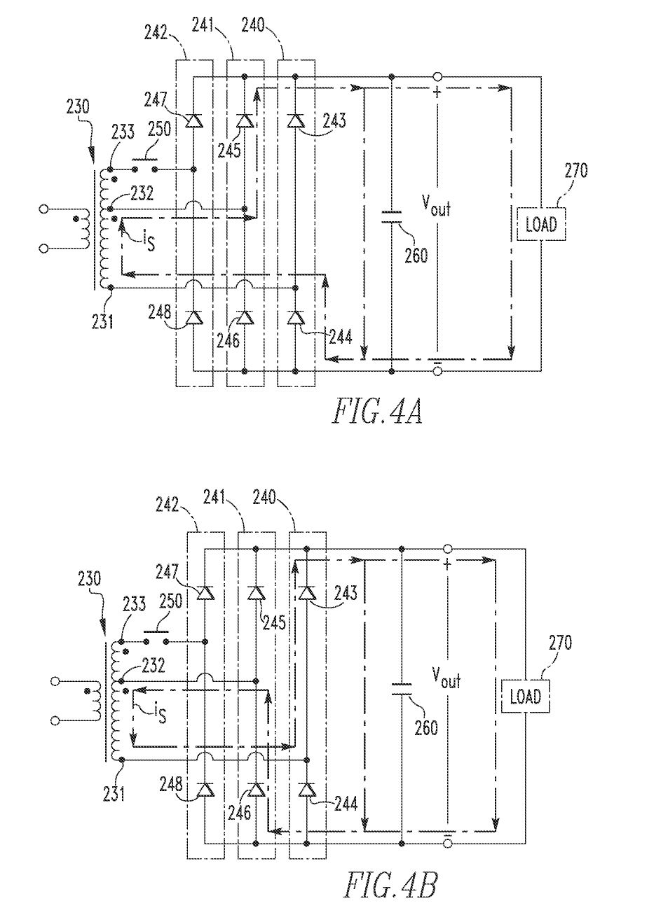

Referring to FIG. 3A, a DC/DC converter 1 in accordance with one non-limiting example embodiment of the disclosed concept is shown. An input voltage V_{IN} is received on a primary side of the DC/DC converter 1. The primary side of the DC/DC converter 1 includes a full-bridge circuit 210 which receives the input voltage V_{IN} and drives a resonant network 220. The full-bridge circuit 210 includes four power switches 211,212,213,214 which are controlled by a control unit 280. The resonant network 220 includes the series combination of a first inductor 221 and a first capacitor 222. The first inductor 221 may be a discrete component or it may be leakage inductance of transformer 230

Transformer 230 has primary and secondary windings. The primary winding of the transformer 230 is electrically connected to the resonant network 220. The transformer 230 has a magnetic inductance component. The magnetic inductance component may be caused by, for example and without limitation, a ferromagnetic core (not shown) of the transformer 230. The transformer 230 isolates the primary and secondary sides of the DC/DC converter 1 from each other.

The secondary winding of the transformer 230 includes three taps. The common tap 231 is electrically connected to a first rectifier circuit 240 and the first tap 232 is electrically connected to a second rectifier circuit 241. The second tap 233 is electrically connected to a first side of a switch 250. A second side of the switch 250 is electrically connected to a third rectifier circuit 242. The output voltage V_{OUT} of the DC/DC converter 1 is provided on the secondary side of the DC/DC converter 1. Additionally, a filtering capacitor 260 is electrically connected between the output terminals of the DC/DC converter to smooth the output voltage V_{OUT}.

The first rectifier circuit 240 includes first and second diodes 243,244. The first diode 243 is electrically connected between the common tap 231 of the transformer 230 and the positive output terminal of the DC/DC converter 1. The second diode 244 is electrically connected between the negative output terminal of the DC/DC converter 1 and the common tap 231 of the transformer 230.

The second rectifier circuit 241 includes first and second diodes 245,246. The first diode 245 is electrically connected between the first tap 232 of the transformer 230 and the positive output terminal of the DC/DC converter 1. The second diode 246 is electrically connected between the negative output terminal of the DC/DC converter 1 and the first tap 232 of the transformer 230.

The third rectifier circuit 242 includes first and second diodes 247,248. The first diode 247 is electrically connected between the second tap 233 of the transformer 230 and the positive output terminal of the DC/DC converter 1 when the switch 250 is closed. The second diode 248 is electrically connected between the negative output terminal of the DC/DC converter 1 and the second tap 233 of the transformer 230 when the switch 250 is closed.

The control unit 280 senses the output voltage V_{OUT} of the DC/DC converter 1 and controls the switching of the power switches 211,212,213,214 in the full-bridge circuit 210. Changing the frequency at which the power switches 211,212,213,214 are switched adjusts the output voltage V_{OUT}. However, adjusting the frequency at which the power switches 211,212,213,214 are switched also affects the efficiency of the DC/DC converter 1. As such, it is desirable to switch the power switches 211,212,213,214 at an optimally efficient frequency as much as possible.

The control unit 280 can also control a transition of the switch 250. Generally, the control unit 280 controls the frequency at which the power switches 211,212,213,214 are switched based on feedback from the output voltage V_{OUT}. However, the transition of the switch 250 can cause a spike in the output voltage V_{OUT} faster than the control unit 280 can sense the change in the output voltage V_{OUT} and responsively adjust the frequency at which the switches 211,212,213,214 are switched. To prevent the voltage spike and provide a smoother output voltage during transitions of the switch 250, the control unit 280 can simultaneously control the transition of the switch 250 and adjust the frequency at which the power switches 211,212,213,214 are switched to account for the transition of the switch 250.

Referring to FIG. 3B, a DC/DC converter 1′ in accordance with another non-limiting example embodiment of the disclosed concept is shown. The secondary side of the DC/DC converter 1′ is substantially similar to the secondary side of the DC/DC converter 1 shown in FIG. 3A. However, rather than including the full-bridge circuit 210, the primary side of the DC/DC converter 1′ includes a half-bridge circuit 310 having two power switches 311,312 that are controlled by the control unit 280.

In both the DC/DC converters 1,1′ shown in FIGS. 3A and 3B, a level of the output voltage V_{OUT} can be changed by operating the switch 250. When the switch 250 is open, current flows through the first tap 232 of the secondary winding, and when the switch is closed, current flows through the second tap 233 of the secondary winding, thus changing the output voltage V_{OUT} of the DC/DC converter 1,1′.

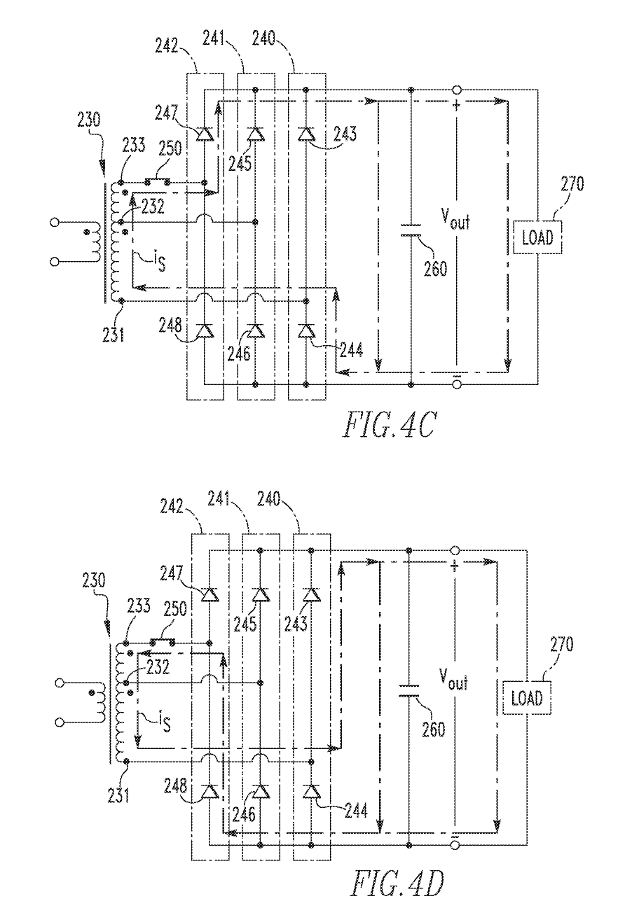

Referring now to FIGS. 4A-4D, a current path iₛ in the secondary side of a DC/DC converter is shown. The primary side of the DC/DC converter is not shown in FIGS. 4A-4D. However, it is readily understood that a suitable primary side of the DC/DC converters 1,1′ shown in FIG. 3A or 3B may be used in conjunction with the secondary side shown in FIGS. 4A-4D.

Referring to FIG. 4A, the switch 250 is open and current in the secondary winding of the transformer 230 flows in a direction from the common tap 231 to the first tap 232. The current flows from the first tap 232 to the second rectifier circuit 241. The current then flows through the diode 245 of the second rectifier circuit 241 and through filtering capacitor 260 as well as out of the positive output terminal of the DC/DC converter to any load 270 (shown in phantom line drawing) electrically connected thereto. The current then flows back into the DC/DC converter through the negative output terminal, through the diode 244 of the first rectifier circuit 240, and to the common tap 231. Current does not flow through the second tap 233 when the switch 250 is open.

In FIG. 4B, the current path iₛ in the secondary side of the transformer 230 is shown when the direction of the current in the secondary winding of the transformer 230 is reversed. Similar to FIG. 4A, the switch 250 is open in FIG. 4B. However, in FIG. 4B, the current in the secondary winding of the transformer 230 flows in a direction from the first tap 232 to the common tap 231. The current flows from the common tap 231 to the first rectifier circuit 240. The current then flows through the diode 243 of the first rectifier circuit 240 and through the filtering capacitor 260 as well as out of the positive output terminal of the DC/DC converter to any load 270 (shown in phantom line drawing) electrically connected thereto. The current then flows back into the DC/DC converter through the negative output terminal, through the diode 246 of the second rectifier circuit 241, and to the first tap 232.

In FIG. 4C, a current path iₛ when the switch 250 is closed is shown. The current in the secondary winding of the transformer 230 flows in a direction from the common tap 231 to the second tap 233. The current flows from the second tap 233 to the third rectifier circuit 242. The current then flows through the diode 247 of the third rectifier circuit 242 and through the filtering capacitor as well as out the positive output terminal of the DC/DC converter to any load 270 (shown in phantom line drawing) electrically connected thereto. The current then flows back into the DC/DC converter through the negative output terminal, through the diode 244 of the first rectifier circuit 240, and to the common tap 231. When the switch 250 is closed, current flows through the second tap 233.

In FIG. 4D, the current path iₛ in the secondary side of the transformer 230 is shown. Here, the direction of the current in the secondary winding of the transformer 230 is reversed. Similar to FIG. 4C, the switch 250 is closed in FIG. 4D. However, in FIG. 4D, the current in the secondary winding of the transformer 230 flows in a direction from the second tap 233 to the common tap 231. The current flows from the common tap 231 to the first rectifier circuit 240. The current then flows through the diode 243 of the first rectifier circuit 240 and through the filtering capacitor as well as out of the positive output terminal of the DC/DC converter to any load 270 (shown in phantom line drawing) electrically connected thereto. The current then flows back into the DC/DC converter through the negative output terminal, through the diode 248 of the third rectifier circuit 242, and to the second tap 233. When the switch 250 is closed and current flows through the second tap 233, as shown in FIGS. 4C and 4D, the output voltage V_{OUT} is increased compared with when the switch 250 is open and current does not flow through the second tap 233, as shown in FIGS. 4A and 4B. Additionally, during a transition period (i.e., a period when the switch 250 changes from open to closed or from closed to open) of the switch 250, current is able to flow through the secondary side of the DC/DC converter on one of the current paths iₛ shown in FIGS. 4A and 4B. As such, voltage spikes at the output of the DC/DC converter are avoided and the DC/DC converter can be reliably used during transition periods of the switch 250.

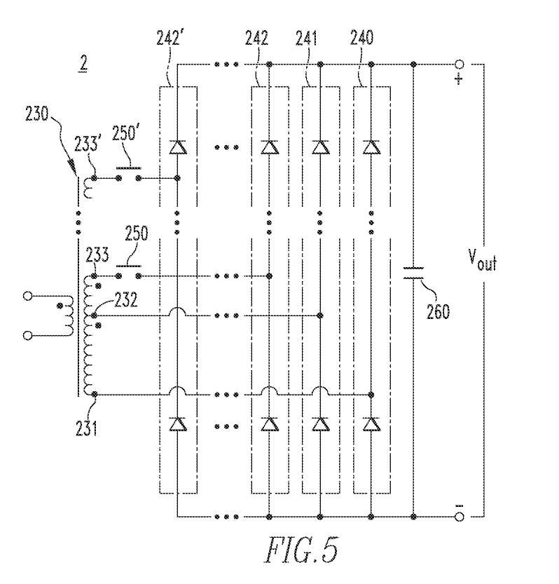

Referring to FIG. 5, the secondary side of a DC/DC converter 2 in accordance with another example embodiment of the disclosed concept is shown. The DC/DC converter 2 is similar to the DC/DC converters 1,1′ shown in FIGS. 3A and 3B and may also include a suitable primary side such as the primary sides from either of the DC/DC converters 1,1′. However, the DC/DC converter 2 shown in FIG. 5 can have any number of additional taps 233′ on the secondary winding of the transformer 230 along with their corresponding additional switches 250′ and additional rectifier circuits 242′. In the DC/DC converter 2, the output voltage V_{OUT} can be controlled by controlling the switches 250,250′. A greater number of additional switches 250′ can be used to provide a wider and/or more finely tunable output voltage V_{OUT} range.

The DC/DC converters 1,1′,2 of FIGS. 3A, 3B, and 5 are configured as LLC resonant converters. In an LLC resonant converter, the resonant frequency of the primary side is determined by two inductive components (e.g., without limitation, inductor 221 and the magnetizing inductance of the transformer 230) and a capacitance (e.g., without limitation, capacitor 222). However, it is contemplated that the principles of the disclosed concept can also be applied to other types of DC/DC converters. For example and without limitation, it is contemplated that primary sides of the DC/DC converters 1,1′,2 can be modified to change the DC/DC converters 1,1′,2 to LCC resonant converters without departing from the scope of the disclosed concept. In an LCC resonant converter, the resonant frequency of the primary side is determined by one inductive component and two capacitive components. A capacitor can be electrically connected in parallel with the primary winding of the transformer 230 to convert any of the disclosed DC/DC converters into an LCC resonant converter.

Additionally, it is contemplated that the primary sides of the DC/DC converters 1,1′,2 can be structured as series resonant converters (e.g., without limitation, the resonant network 220 includes an inductor in series with a capacitor), parallel resonant converters (e.g., without limitation, the resonant network 220 includes an inductor and capacitor in parallel with the primary winding of the transformer 230), or series parallel resonant converters (e.g., without limitation, the resonant network 220 includes an inductor in series with a capacitor and a capacitor in parallel with the primary winding of the transformer 230) without departing from the scope of the disclosed concept.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A DC/DC converter configured to receive an input voltage and to output an output voltage, said DC/DC converter comprising:
a bridge circuit configured to receive said input voltage and including at least one pair of power switches;
a resonant network driven by the bridge circuit;
a transformer having a primary winding electrically connected to the resonant network and a secondary winding having a plurality of taps including a common tap, a first tap, and a second tap;
a plurality of rectifier circuits configured to output said output voltage, said rectifier circuits including a first rectifier circuit electrically connected to said common tap, a second rectifier circuit electrically connected to said first tap, and a third rectifier circuit electrically connectable to said second tap;
a switch electrically connected between said second tap and said third rectifier circuit, wherein said switch is operable to electrically connect and disconnect said third rectifier circuit from said second tap; and
a control unit configured to control switching of said at least one pair of power switches.

2. The DC/DC converter of claim 1, wherein said bridge circuit is a half-bridge circuit comprising one pair of power switches; and wherein said resonant network is electrically connected between said one pair of power switches and the primary winding of said transformer.

3. The DC/DC converter of claim 1, wherein said bridge circuit is a full-bridge circuit comprising two pairs of power switches; and wherein said resonant network is electrically connected between one of said two pairs of power switches and the primary winding of said transformer.

4. The DC/DC converter of claim 1, wherein said control unit senses said output voltage and adjusts a switching frequency of said at least one pair of power switches based on said sensed output voltage.

5. The DC/DC converter of claim 1, wherein said control unit controls switching of the switch.

6. The DC/DC converter of claim 5, wherein said control unit simultaneously controls switching of the switch and adjusts a switching frequency of said at least one pair of power switches.

7. The DC/DC converter of claim 1, wherein said resonant network includes an inductor and a capacitor electrically connected in series.

8. The DC/DC converter of claim 1, wherein said DC/DC converter is structured as at least one of a series resonant converter, a parallel resonant converter, and a series parallel resonant converter.

9. The DC/DC converter of claim 1, wherein said DC/DC converter is structured as at least one of an LLC resonant converter and an LCC resonant converter.

10. The DC/DC converter of claim 1, wherein when said switch is open, a current flows through the common tap and the first tap of said transformer and does not flow through the second tap of said transformer; and wherein when said switch is closed, a current flows through said the common tap and the second tap of said transformer.

11. The DC/DC converter of claim 1, wherein said DC/DC converter includes a positive output terminal and a negative output terminal; wherein said first rectifier circuit comprises a first diode electrically connected between said positive output terminal and said common tap and a second diode electrically connected between said negative output terminal and said common tap; wherein said second rectifier circuit comprises a first diode electrically connected between said positive output terminal and said first tap and a second diode electrically connected between said negative output terminal and said first tap; and wherein said third rectifier circuit comprises a first diode electrically connected between said positive output terminal and said second tap when said switch is closed and a second diode electrically connected between said negative output terminal and said second tap when said switch is closed.

12. A DC/DC converter configured to receive an input voltage and to output an output voltage, said DC/DC converter comprising:
a bridge circuit configured to receive said input voltage and including at least one pair of power switches;
a resonant network driven by the bridge circuit;
a transformer having a primary winding electrically connected to the resonant network and a secondary winding having a plurality of taps including a common tap, a first tap, and a number of additional taps;
a plurality of rectifier circuits configured to output said output voltage, said rectifier circuits including a first rectifier circuit electrically connected to said common tap, a second rectifier circuit electrically connected to said first tap, and a number of additional rectifier circuits electrically connectable to said number of additional taps, respectively;
a number of switches electrically connected between said number of additional taps and said number of additional rectifier circuits, respectively, wherein said number of switches are operable to selectively electrically connect and disconnect said number of additional rectifier circuits from said number of additional taps; and
a control unit configured to control switching of said at least one pair of power switches.

13. The DC/DC converter of claim 12, wherein said bridge circuit is a half-bridge circuit comprising one pair of power switches; and wherein said resonant network is electrically connected between said one pair of power switches and the primary winding of said transformer.

14. The DC/DC converter of claim 12, wherein said bridge circuit is a full-bridge circuit comprising two pairs of power switches; and wherein said resonant network is electrically connected between one of said two pairs of power switches and the primary winding of said transformer.

15. The DC/DC converter of claim 12, wherein said control unit senses said output voltage and adjusts a switching frequency of said at least one pair of power switches based on said sensed output voltage.

16. The DC/DC converter of claim 12, wherein said control unit controls switching of the number of switches.

17. The DC/DC converter of claim 16, wherein said control unit simultaneously control switching of one or more of the number of switches and adjusts a switching frequency of said at least one pair of power switches.

18. The DC/DC converter of claim 12, wherein said resonant network includes an inductor and a capacitor connected in series.

19. The DC/DC converter of claim 12, wherein said DC/DC converter is structured as at least one of a series resonant converter, a parallel resonant converter, and a series parallel resonant converter.

20. The DC/DC converter of claim 12, wherein said DC/DC converter is structured as at least one of an LLC resonant converter and an LCC resonant converter.
